(19) United States
(12) Patent Application Publication
(10) Pub. No.: US 2025/0095915 A1
(43) Pub. Date: Mar. 20, 2025

(54) HIGH-COERCIVITY NEODYMIUM-CERIUM-IRON-BORON PERMANENT MAGNET AS WELL AS PREPARATION METHOD THEREFOR AND USE THEREOF

(71) Applicant: YANTAI ZHENGHAI MAGNETIC MATERIAL CO., LTD., Yantai, Shandong (CN)

(72) Inventors: Yongjiang YU, Yantai, Shandong (CN); Zhongxin AN, Yantai, Shandong (CN); Lei LIU, Yantai, Shandong (CN); Congcong ZHANG, Yantai, Shandong (CN); Guoqiang GENG, Yantai, Shandong (CN)

(21) Appl. No.: 18/724,504

(22) PCT Filed: Nov. 28, 2022
(86) PCT No.: PCT/CN2022/134599

§ 371 Date: Jun. 26, 2024

(30) Foreign Application Priority Data
Dec. 27, 2021 (CN) 202111619345.1

(51) Int. Cl. H01F 41/02

(52) U.S. Cl. CPC H01F 41/0293; H01F 41/0266

(57) ABSTRACT

A high-coercivity neodymium-cerium-iron-boron permanent magnet has at least one of the following features: the area of grain boundary RE-rich phases in the magnet accounts for 4% or more of the area of a whole field of view; the grain boundary RE-rich phases in the magnet are fine and uniformly distributed; and the mean value of ratios of the area of block-shaped grain boundary RE-rich phases located at intersections of three or more main-phase grains to the total area of all the three or more adjacent main-phase grains in the vicinity is less than or equal to 30%. RE-rich phases in the magnet are continuously distributed along grain boundaries, thereby increasing the depth of diffusion of a diffusion source into the magnet, improve the uniformity of distribution of the diffusion source in the, and thus further improving the magnetic performance of the diffusion magnet.

The present application claims priority to the prior application with the patent application No. 202111619345.1, entitled “HIGH-COERCIVITY NEODYMIUM-CERIUM-IRON-BORON PERMANENT MAGNET AS WELL AS PREPARATION METHOD THEREFOR AND USE THEREOF” and filed with the China National Intellectual Property Administration on Dec. 27, 2021, which is incorporated herein by reference in its entirety.

### TECHNICAL FIELD

The present disclosure belongs to the field of rare earth permanent magnets and particularly relates to a high-coercivity neodymium-cerium-iron-boron permanent magnet, a preparation method therefor, and use thereof.

### BACKGROUND

Sintered neodymium-iron-boron, as the third-generation rare earth permanent magnet material, mainly consists of elements such as the rare earth PrNd, iron, boron, etc., and is widely utilized in the fields of various rare earth permanent magnet motors, intelligent consumer electronic products, medical devices, etc. due to its excellent magnetic performance and high cost-effectiveness. With the rapid development of low-carbon, environment-friendly, economical, and high-new technologies, the demand for sintered neodymium-iron-boron magnets is increasing day by day, which greatly drives the consumption of rare earth PrNd resources, so that the price of PrNd is gradually increased. Ce, being the most abundant rare earth element and having chemical properties similar to those of PrNd, can be used to replace Pr and Nd in sintered neodymium-iron-boron. This not only reduces starting material costs but also promotes the balanced utilization of rare earth resources.

However, due to its mixed valence characteristics, Ce, the ionic radius of which is relatively small, easily forms CeFe₂ phases. Such phases tend to exist as separate grains within the magnet, resulting in a lack of RE-rich phases distributed along the grain boundaries between main phase grains. This makes it easier for anti-magnetization domains to nucleate and expand, making it difficult for the magnet to achieve high coercivity. Meanwhile, the magnetic exchange coupling effect produced by the direct contact between adjacent main phase grains also significantly reduces the residual magnetic flux density of the magnet. In contrast, NdFe₂ phases are difficult to form within the magnet. Therefore, to achieve the preparation of high-performance Ce-rich neodymium-cerium-iron-boron magnets, it is crucial to inhibit the presence of CeFe₂ phases in the form of grains and optimize the distribution of RE-rich phases within neodymium-cerium-iron-boron magnets. These are the urgent technical problems that need to be addressed.

### SUMMARY

To alleviate the technical problems described above, the present disclosure provides a neodymium-cerium-iron-boron permanent magnet, wherein the neodymium-cerium-iron-boron permanent magnet has at least one of the following characteristics:
the area of grain boundary RE-rich phases within the magnet accounts for no less than 4% of an entire visual field area;
the grain boundary RE-rich phases within the magnet exhibit a uniform and fine distribution;
the mean ratio of the area of block-like grain boundary RE-rich phases at the junction of no less than three main phase grains to the total area of all of no less than three nearby adjacent main phase grains is ≤30%.

According to an embodiment of the present disclosure, the distribution of the block-like grain boundary RE-rich phases at the junction of no less than three main phase grains and all of no less than three nearby, adjacent main phase grains is substantially as shown in FIG. 3.

According to an embodiment of the present disclosure, the RE comprises neodymium (Nd) and may also comprise at least one rare earth element selected from the following: cerium (Ce), lanthanum (La), praseodymium (Pr), yttrium (Y), gadolinium (Gd), terbium (Tb), dysprosium (Dy), holmium (Ho), etc.

According to an embodiment of the present disclosure, the area of grain boundary RE-rich phases within the magnet accounts for no less than 6% of the entire visual field area.

According to an embodiment of the present disclosure, the mean ratio of the area of block-like grain boundary RE-rich phases at the junction of no less than three main phase grains to the total area of all of no less than three nearby adjacent main phase grains is ≤15%, more preferably ≤10%, and more preferably ≤7%.

In the present disclosure, the vertically oriented surface of the neodymium-cerium-iron-boron permanent magnet is polished and analyzed using a field-emission electron probe microanalyzer (FE-EPMA) (JEOL, 8530F), and area ratios are analyzed using Image-Pro Plus software. In the present disclosure, the visual field area refers to the image display range analyzed by FE-EPMA or SEM, and the magnification of the test sample image is not limited and is illustratively 200, 500, 800, 1000, or 1500.

In the present disclosure, the adjacent main phase grains refer to the main phase grains adjacent to the grain boundary RE-rich phases.

According to an embodiment of the present disclosure, the main phase has an R₂Fe₁₄B structure.

According to an embodiment of the present disclosure, main phase grains of the neodymium-cerium-iron-boron permanent magnet have a mean grain size of 5-10 μm.

According to an embodiment of the present disclosure, the neodymium-cerium-iron-boron permanent magnet has the following chemical formula: (CeₐRH_{b}RL_{1-a-b})ₓFe_{100-x-y-z}TM_{y}B_{z};
wherein: 20≤x≤40, 0.5≤y≤10, 0.9≤z≤1.5, 0.05≤a≤0.65, and 0≤b≤0.25; the element RH is at least one of Dy, Tb, Ho, and Gd, and the element RL is selected from at least one of Pr, Nd, La, and Y and comprises at least Nd; the element TM is at least one of Co, Cu, Ga, Al, Zr, and Ti.

According to an embodiment of the present disclosure, the element RH is preferably Dy.

According to an embodiment of the present disclosure, the element RL is preferably Pr or Nd.

According to an embodiment of the present disclosure, the element TM is a mixture of Co, Cu, Ga, Al, Zr, and Ti.

According to an embodiment of the present disclosure, 25≤x≤35, 1≤y≤5, 0.9≤z≤1.3, 0.05≤a≤0.25, and 0.01≤b≤0.1.

The present disclosure also provides a preparation method for the neodymium-cerium-iron-boron permanent magnet described above, the method comprising subjecting starting materials comprising element Ce, element RL, element Fe, element TM, and element B and a starting material of the element RH, which is optionally present or absent, to powder preparation, pressing, sintering, and an aging treatment to prepare and obtain the neodymium-cerium-iron-boron permanent magnet;
wherein the element RL, the element TM, and the element RH have the meanings described above. According to an embodiment of the present disclosure, the method comprises subjecting starting materials comprising the element Ce, the element RL, the element Fe, the element TM, the element B, and the element RH to powder preparation, pressing, and sintering to prepare and obtain the neodymium-cerium-iron-boron permanent magnet.

According to an embodiment of the present disclosure, the starting materials are added in the (CeₐRH_{b}RL_{1-a-b})ₓFe_{100-x-y-z}TM_{y}B_{z} stoichiometric ratio.

According to an embodiment of the present disclosure, a lubricant may be added in the preparation process of the permanent magnet, wherein the lubricant is selected from one or more of calcium stearate, zinc stearate, tributyl borate, isopropanol, petroleum ether, etc. Preferably, the lubricant may be used in an amount of 0.01-2 wt %, illustratively 0.01 wt %, 0.05 wt %, 0.1 wt %, 0.5 wt %, 1 wt %, or 2 wt % of a total weight of the powder.

According to an embodiment of the present disclosure, the method comprises: preparing starting materials comprising the element Ce, the element RL, the element Fe, the element TM, the element B, and the element RH into alloy scales first, then subjecting the alloy scales to hydrogen decrepitation, dehydrogenation, and milling to prepare an alloy powder, and performing pressing, sintering, and an aging treatment to prepare and obtain the neodymium-cerium-iron-boron permanent magnet.

According to an embodiment of the present disclosure, the method may also comprise: (K1) preparing Ce-free main phase alloy scales and Ce-containing auxiliary phase alloy scales first;
wherein the Ce-free main phase alloy scales are prepared by subjecting starting materials of the element RL, the element Fe, the element TM, and the element B, and the element RH, which is optionally present or absent, to smelting and condensation;
the Ce-containing auxiliary phase alloy scales are prepared by subjecting starting materials of the element Ce, the element RL, the element Fe, the element TM, and the element B, and the element RH, which is optionally present or absent, to smelting and condensation;
(K2) subjecting the Ce-free main phase alloy scales and the Ce-containing auxiliary phase alloy scales of step (K1) to hydrogen decrepitation, dehydrogenation, and jet milling to prepare alloy powders, optionally adding the lubricant or not, and performing pressing, sintering, and the aging treatment to prepare and obtain the neodymium-cerium-iron-boron permanent magnet.

According to an embodiment of the present disclosure, the method may also comprise: (K1) preparing Ce-free main phase alloy scales and Ce-containing auxiliary phase alloy scales first;
wherein the Ce-free main phase alloy scales are prepared by subjecting starting materials of the element RL, the element RH, the element Fe, the element TM, and the element B to smelting and condensation;
the Ce-containing auxiliary phase alloy scales are prepared by subjecting starting materials of the element Ce, the element RL, the element RH, the element Fe, the element TM, and the element B to smelting and condensation;
(K2) subjecting the Ce-free main phase alloy scales and the Ce-containing auxiliary phase alloy scales of step (K1) to hydrogen decrepitation, dehydrogenation, and jet milling to prepare alloy powders, optionally adding the lubricant or not, and performing pressing, sintering, and the aging treatment to prepare and obtain the neodymium-cerium-iron-boron permanent magnet.

According to an embodiment of the present disclosure, in step (K2), the neodymium-cerium-iron-boron permanent magnet is prepared and obtained by subjecting the Ce-free main phase alloy scales and the Ce-containing auxiliary phase alloy scales of step (K1) to hydrogen decrepitation, dehydrogenation, and jet milling to prepare alloy powders, adding the lubricant, and performing pressing and sintering.

According to an embodiment of the present disclosure, the method may also comprise: (S1) preparing Ce-free main phase alloy scales and Ce-containing auxiliary phase alloy scales first, and subjecting the Ce-free main phase alloy scales and the Ce-containing auxiliary phase alloy scales to hydrogen decrepitation, dehydrogenation, and jet milling to prepare a main phase alloy powder and an auxiliary phase alloy powder, respectively;
wherein the Ce-free main phase alloy scales and the Ce-containing auxiliary phase alloy scales have the meanings described above;
(S2) mixing the main phase alloy powder and the auxiliary phase alloy powder of step (S1), optionally adding the lubricant or not, and performing pressing, sintering, and the aging treatment to prepare and obtain the neodymium-cerium-iron-boron permanent magnet.

According to an embodiment of the present disclosure, in step (S2), the neodymium-cerium-iron-boron permanent magnet is prepared and obtained by mixing the main phase alloy powder and the auxiliary phase alloy powder of step (S1), adding the lubricant, and performing pressing, sintering, and the aging treatment.

According to an embodiment of the present disclosure, in step (S2), the mass ratio of the main phase alloy powder to the auxiliary phase alloy powder is (1-40):1, illustratively 2.7:1 or 10:1.

According to an embodiment of the present disclosure, the alloy scales (including the main phase alloy scales and the auxiliary phase alloy scales) have a thickness of 0.1-0.4 mm, illustratively 0.1 mm, 0.2 mm, 0.25 mm, 0.3 mm, or 0.4 mm.

According to an embodiment of the present disclosure, the alloy scales (including the main phase alloy scales and the auxiliary phase alloy scales) are prepared and obtained by subjecting the starting materials to vacuum smelting followed by casting. Illustratively, the smelting of the alloy scales is performed in a vacuum induction furnace.

Preferably, the smelting is performed in an inert atmosphere, for example, in a nitrogen or argon atmosphere, preferably in an argon atmosphere.

Preferably, a casting temperature of the alloy scale smelting process is 1300-1500° C., illustratively 1300° C., 1400° C., or 1500° C.

Preferably, the casting process of the alloy scales is casting the molten liquid of starting materials onto a rotating water-cooled copper roller. Further, the rotating water-cooled copper roller has a rotation speed of 15-45 rpm, illustratively 15 rpm, 20 rpm, 25 rpm, 30 rpm, 40 rpm, or 45 rpm.

Preferably, the alloy powders (including the main phase alloy powder and the auxiliary phase alloy powder) have a mean grain size of 2-6 μm, illustratively 2 μm, 3 μm, 3.5 μm, 4 μm, 5 μm, or 6 μm. Illustratively, the main phase alloy powder has a mean grain size of 4-6 μm; the auxiliary phase alloy powder has a mean grain size of 3-5 μm.

According to an embodiment of the present disclosure, the preparation method also comprises press-molding the alloy powders into a compact.

According to an embodiment of the present disclosure, the press molding comprises orientated press molding and isostatic press molding. Preferably, the orientated press molding is performed first, and the isostatic press molding is then performed to prepare and obtain a compact with increased density. Further, the orientated pressing is performed in a magnetic field, and the isostatic press molding is performed in an isostatic press.

Preferably, the mixed powder is subjected to orientated press molding in an inert atmosphere, for example, in a nitrogen or argon atmosphere, preferably in a nitrogen atmosphere.

Preferably, the orientation magnetic field has a magnetic field strength of 2-5 T, illustratively 2 T, 3 T, 4 T, or 5 T.

Preferably, the isostatic press molding is performed at a pressure of 150-260 MPa, illustratively 150 MPa, 180 MPa, 185 MPa, 200 MPa, 220 MPa, 240 MPa, or 260 MPa.

Preferably, the compact has a density of 4-6 g/cm³, illustratively 4 g/cm³, 4.2 g/cm³, 4.6 g/cm³, 5 g/cm³, or 6 g/cm³.

According to an embodiment of the present disclosure, before the sintering treatment, the compact is subjected to a heating treatment at a temperature of 100-950° C., preferably 150-900° C., with a heating treatment incubation time of 60-120 min; illustratively, the heating treatment temperature has 3-6 stages; the incubation temperature of each stage of the heating treatment may be the same or different, and the incubation time may be the same or different; the heating treatment stages may be performed under inert gas or vacuum. Illustratively, the temperature of the heat treatment has 4 stages, which are 100-200° C., 200-550° C., 550-700° C., and 700-950° C.

According to an embodiment of the present disclosure, the sintering is vacuum liquid-phase sintering having no less than four sintering-incubation stages, e.g., 4-10 sintering-incubation stages; temperatures of the sintering-incubation stages are 900-1150° C., preferably 950-1100° C., illustratively 900° C., 950° C., 1000° C., 1010° C., 1015° C., 1030° C., 1040° C., 1050° C., 1070° C., or 1100° C.; incubation temperatures of a plurality of incubation stages may be the same or different. Incubation times are 40-140 min, preferably 50-100 min, illustratively 40 min, 50 min, 60 min, 70 min, 80 min, 90 min, or 110 min, and the incubation times may be the same or different. The sintering-incubation stages may be performed under inert gas or vacuum.

Preferably, each of the sintering-incubation stages is preceded by a heating stage, and the heating rate of the heating stage is 0.5-5° C./min, more preferably 1-4° C./min; the heating rate of each heating stage may be the same or different.

According to an embodiment of the present disclosure, between every two adjacent sintering-incubation processes, the previous sintering-incubation stage may be immediately followed by the next heating-incubation procedure, or after the previous sintering-incubation stage, cooling may be performed before the next heating-incubation procedure, wherein the temperature of the cooling is not limited, so long as the temperature is lower than the temperature of the previous sintering-incubation stage; the number of stages of the cooling is not particularly limited, so long as the desired cooling temperature is achieved; that is, between every two adjacent sintering-incubation processes, the processes may be random. For example, after the previous sintering-incubation stage, 1-10 stages of cooling are performed before the next heating-incubation procedure, wherein the temperatures of the 1-10 stages of cooling may be the same or different. Illustratively, after incubation, the temperature of cooling is 500-1050° C.

According to an embodiment of the present disclosure, the aging treatment is performed after the sintering treatment cooling. Illustratively, the aging treatment comprises: after sintering is complete, cooling to room temperature, and then performing a heating treatment.

Preferably, the aging treatment is a two-stage aging treatment comprising: heating to perform a primary aging treatment at a temperature of 800-950° C., with an incubation time of 160-300 min; cooling to a temperature of no more than 210° C., and then heating to perform a secondary aging treatment at a temperature between 450° C. and 600° C., with an incubation time of 240-360 min.

According to an embodiment of the present disclosure, the preparation method for the neodymium-cerium-iron-boron permanent magnet comprises the following steps:
step 1: weighing and proportioning according to the (CeₐRH_{b}RL_{1-a-b})ₓFe_{100-x-y-z}TM_{y}B_{z} ingredients and proportions, smelting in a vacuum induction furnace in an Ar atmosphere, casting the molten liquid onto a rotating quenching roller, and after strip casting to a cooling disc for cooling, preparing alloy scales;
step 2: after subjecting the alloy scales to hydrogen decrepitation, dehydrogenation, and jet milling treatments, preparing an alloy powder;
step 3: subjecting the alloy powder to orientated press molding in a magnetic field to prepare and obtain a compact, and pressing the compact using an isostatic press to further improve the density of the compact; and
step 4: subjecting the compact to sintering having N sintering-incubation stages in a sintering furnace and to an aging treatment to prepare and obtain the neodymium-cerium-iron-boron permanent magnet, wherein 4≤N≤10.

According to an embodiment of the present disclosure, the method also comprises a grain boundary diffusion treatment step: after grinding the surface of the neodymium-cerium-iron-boron permanent magnet prepared after sintering, coating the surface with a heavy rare earth diffusion source, and after a diffusion treatment, preparing a grain boundary diffusion neodymium-cerium-iron-boron permanent magnet.

Preferably, the diffusion treatment comprises applying a diffusion material to the surface of the magnet, and performing a vacuum heating diffusion treatment, diffusion cooling, and a diffusion aging treatment.

According to an embodiment of the present disclosure, one or more of pure metals, alloys, compounds, etc. of the heavy rare earth RH (Dy, Tb), illustratively at least one of pure metals of Dy and/or Tb, hydrides of Dy and/or Tb, oxides of Dy and/or Tb, hydroxides of Dy and/or Tb, fluorides of Dy and/or Tb, etc., and illustratively dysprosium fluoride, may be allowed to adhere to the surface of the neodymium-cerium-iron-boron permanent magnet by means of spray coating.

According to an embodiment of the present disclosure, the diffusion treatment may be performed in a vacuum heat treatment furnace.

Preferably, the vacuum heating diffusion treatment is performed at a temperature of 800-980° C. for a time period of 5-45 h.

Preferably, the diffusion cooling is performed at a temperature below 100° C.

Preferably, the diffusion aging treatment is performed at a temperature of 420-650° C., e.g., 550° C., for a time period of 3-10 h.

According to an embodiment of the present disclosure, after the sintering procedure and before the diffusion treatment, the compact may be processed to target dimensions.

The present disclosure also provides use of the neodymium-cerium-iron-boron permanent magnet described above in the fields of rare earth permanent magnet motors, intelligent consumer electronic products, medical devices, etc.

### Advantageous Effects of Present Disclosure

In the present disclosure, by adjusting the substrate formula, the preparation method, and the sintering scheme of neodymium-cerium-iron-boron, reducing the movement distance of the solid-liquid interface on the surface of the main phase grains of neodymium-cerium-iron-boron towards the solid phase, slowing down the melting of the main phase grains, inhibiting the growth of the main phase grains, and enhancing the capillary action of the grain boundaries, the molten RE-rich phases are distributed along the grain boundaries, and the ratio of the area of block-like grain boundary RE-rich phases at the junction of no less than three main phase grains to the total area of all of no less than three nearby, adjacent grains is reduced, so that the ratio of the area of RE-rich phases within the magnet to the entire visual field area is reduced and RE-rich phases exhibit a uniform, fine distribution. Meanwhile, continuous, smooth thin-layer grain boundary RE-rich phases are formed to divide and surround the main phase grains, repairing grain boundary defects, so that anti-magnetization domain nucleation is inhibited, the movement of the anti-magnetization domain wall is hindered, the magnetic exchange coupling effect among the main phase grains is effectively isolated, and the permanent magnet thus has relatively high magnetic performance.

The addition of Ce can change the gradients and structural morphology of the grain boundary phase within the magnet, reduce the melting point of RE-rich phases, reduce the sintering and aging temperatures of the magnet, and make grain boundary RE-rich phases tend to exhibit a block-like distribution. As the Ce content increases, the tendency of the grain boundary phase to exhibit a block-like distribution is more significant. This can increase grain boundary defects and bring main phase grains into contact with each other, thereby reducing magnetic performance. Therefore, in the present disclosure, by further prolonging the sintering period, increasing the incubation time, promoting the distribution of molten RE-rich phases along the main phase grains, improving the proportion of two-grain grain boundary RE-rich phases to make them exhibit a uniform, fine distribution within the magnet, and reducing defects to inhibit anti-magnetization domain nucleation, the microstructure and magnetic performance of the magnet are optimized.

In addition, the magnet prepared by the present disclosure has an excellent diffusion effect when used as a grain boundary diffusion magnet substrate. The continuous distribution of the RE-rich phases within the magnet along the grain boundaries provides more channels for diffusion, which help to increase the diffusion depth of the diffusion source within the magnet, the uniformity of the distribution of the diffusion source within the magnet, and the consistency of the internal composition of the diffusion magnet, thereby improving the magnetic performance of the diffusion magnet.

### BRIEF DESCRIPTION OF THE DRAWINGS

FIG. 1 shows a scanning electron microscope image of the grain boundary phase and the main phase within the magnet of Comparative Example 2.

FIG. 2 shows a scanning electron microscope image of the grain boundary phase and the main phase within the magnet of Example 1.

FIG. 3 is a graph showing the distribution of the block-like grain boundary RE-rich phases at the junction of no less than three main phase grains and all of no less than three nearby, adjacent main phase grains of the present disclosure.

### DETAILED DESCRIPTION

The technical solutions of the present disclosure will be further described in detail with reference to the following specific examples. It should be understood that the following examples are merely exemplary illustration and explanation of the present disclosure and should not be construed as limiting the protection scope of the present disclosure. All techniques implemented based on the contents described above of the present disclosure are encompassed within the protection scope of the present disclosure.

Unless otherwise stated, the starting materials and reagents used in the following examples are all commercially available products or can be prepared by using known methods.

In the following examples of the present disclosure, PrNd was added in the form of an alloy, the remaining metals were added in the form of simple substances, and B was provided by B—Fe sand.

### Example 1

(1) The component proportions were designed on a 100 mass % basis as follows: PrNd: 29 wt. %, Ce: 3.7 wt. %, Dy: 0.4 wt. %, Co: 1.2 wt. %, Cu: 0.3 wt. %, Ga: 0.1 wt. %, Al: 0.53 wt. %, Zr: 0.12 wt. %, Ti: 0.12 wt. %, B: 0.99 wt. %, and Fe balance. Starting materials were weighed out and smelted by using a vacuum induction smelting furnace in an Ar atmosphere, and the molten liquid was cast at a temperature of 1400° C. onto a quenching roller rotating at a rotation speed of 32 rpm to prepare and obtain alloy scales with a mean thickness of 0.25 mm.

(2) The alloy scales were subjected to hydrogen decrepitation, dehydrogenation, and jet milling to prepare an alloy powder with a mean grain size of 3.7 μm, and zinc stearate was added as a lubricant in an amount of 0.05 wt % of the weight of the alloy powder in a N₂ atmosphere and homogenously stirred and mixed.

(3) The mixed powder of step (2) was added to the mold cavity of a press-molding device mold in a N₂ atmosphere, subjected to oriented press molding with an orientation magnetic field strength of 3 T, and then subjected to an isostatic pressing treatment in an isostatic press at a pressure of 185 MPa for 8 s to obtain a compact with a density of 4.2 g/cm³.

(4) The compact was placed in a sintering furnace and treated with heat in a vacuum atmosphere. The compact was incubated at 150° C. for 100 min and 260° C. for 100 min to remove the lubricant, and incubated at 600° C. for 90 min and 900° C. for 90 min to be degassed. Then a 4-stage sintering-incubation process was performed, and after each sintering-incubation stage, the temperature was lowered to 1000° C. before the next heating procedure. The specific sintering process is shown in Table 1. After the fourth sintering-incubation stage, the product was directly cooled to room temperature to obtain a sintered body.

(5) Aging treatment: The sintered body described above was heated to 900° C. and incubated for 180 min, then cooled to 200° C., heated again to 530° C. and incubated for 240 min, and then cooled to room temperature to obtain a post-aging treatment magnet. The neodymium-cerium-iron-boron permanent magnet has the following chemical formula: (Ce_{0.11}RH_{0.01}RL_{0.88})_{33.1}Fe_{63.56}TM_{2.35}B_{0.99};
the element RH was Dy, and the element RL was Pr and Nd; the element TM was Co, Cu, Ga, Al, Zr, and Ti.

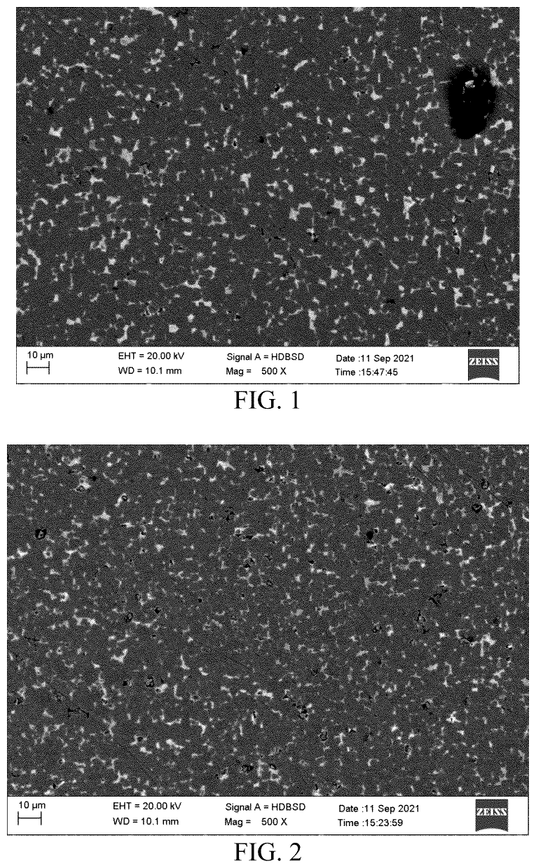

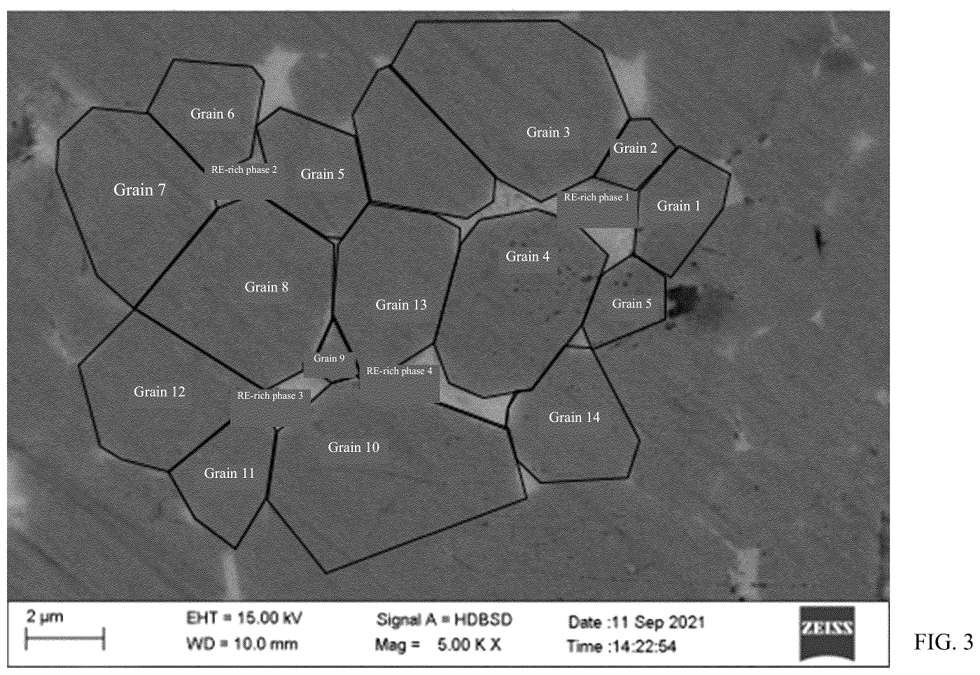

FIG. 2 shows a scanning electron microscope image of the grain boundary phase and the main phase within the magnet of Example 1, and it can be seen from FIG. 2 that the distribution of RE-rich phases was uniform and fine.

### Example 2

Example 2 used the same formula and smelting, milling, pressing, and aging processes as Example 1, and the only difference was that: a 5-stage sintering-incubation process was used. The specific sintering process is shown in Table 1.

### Comparative Example 1

Comparative Example 1 differs from Example 1 in the sintering process. According to the conventional sintering process, heating was performed for one incubation-sintering treatment. The specific sintering process is shown in Table 1.

### Comparative Example 2

Comparative Example 2 differs from Example 1 only in that: Comparative Example 2 used a 3-stage sintering-incubation process, and after each sintering-incubation stage, the temperature was lowered to 1000° C. before the next heating procedure. The specific sintering process is shown in Table 1.

### Comparative Example 3

Comparative Example 3 differs from Example 1 only in that: the component proportions were designed as follows: PrNd: 32.2 wt. %, Ce: 0.5 wt. %, Dy: 0.4 wt. %, Co: 1.2 wt. %, Cu: 0.3 wt. %, Ga: 0.1 wt. %, Al: 0.53%, Zr: 0.12 wt. %, Ti: 0.12 wt. %, B: 0.99 wt. %, and Fe balance. The preparation method was completely the same as that of Example 1, and the neodymium-cerium-iron-boron permanent magnet has the following chemical formula: (Ce_{0.02}RH_{0.01}RL_{0.97})_{33.1}Fe_{63.56}TM_{2.35}B_{0.99};
the element RH was Dy, and the element RL was Pr and Nd; the element TM was Co, Cu, Ga, Al, Zr, and Ti.

FIG. 1 shows a scanning electron microscope image of the grain boundary phase and the main phase within the magnet of Comparative Example 2, and it can be seen from FIG. 1 that the distribution of RE-rich phases was coarse and uneven.

### Comparative Example 4

Comparative Example 4 differs from Comparative Example 3 only in that a 3-stage sintering-incubation process was used. The specific sintering process is shown in Table 1.

TABLE 1
Specific sintering process parameters for Examples 1-2 and Comparative Examples 1-4

| | First | First | First | Second | Second | Second | Third | Third | Third |
|---|---|---|---|---|---|---|---|---|---|
| | heating | incubation | incubation | heating | incubation | incubation | heating | incubation | incubation |
| | rate | temperature | time | rate | temperature | time | rate | temperature | time |
| | (° C./min) | (° C.) | (min) | (° C./min) | (° C.) | (min) | (° C./min) | (° C.) | (min) |
| Example 1 | 3 | 1050 | 80 | 3 | 1050 | 80 | 3 | 1050 | 80 |
| Example 2 | 3 | 1050 | 80 | 3 | 1050 | 80 | 3 | 1050 | 80 |
| Comparative | 3 | 1050 | 300 | — | — | — | — | — | — |
| Example 1 | | | | | | | | | |
| Comparative | 3 | 1050 | 80 | 3 | 1050 | 80 | 3 | 1050 | 80 |
| Example 2 | | | | | | | | | |
| Comparative | 3 | 1050 | 80 | 3 | 1050 | 80 | 3 | 1050 | 80 |
| Example 3 | | | | | | | | | |
| Comparative | 3 | 1050 | 80 | 3 | 1050 | 80 | 3 | 1050 | 80 |
| Example 4 | | | | | | | | | |

| | Fourth | Fourth | Fourth | Fifth | Fifth | Fifth |
|---|---|---|---|---|---|---|
| | heating | incubation | incubation | heating | incubation | incubation |
| | rate | temperature | time | rate | temperature | time |
| | (° C./min) | (° C.) | (min) | (° C./min) | (° C.) | (min) |
| Example 1 | 3 | 1050 | 80 | — | — | — |
| Example 2 | 3 | 1050 | 80 | 3 | 1050 | 80 |
| Comparative | — | — | — | — | — | — |
| Example 1 | | | | | | |
| Comparative | — | — | — | — | — | — |
| Example 2 | | | | | | |
| Comparative | 3 | 1050 | 80 | — | — | — |
| Example 3 | | | | | | |
| Comparative | — | — | — | — | — | — |
| Example 4 | | | | | | |

### Example 3

In Example 3, the post-sintering aging magnet of Example 1 was used and processed into a sheet product measuring 20 mm in length, 20 mm in width, and 5 mm in thickness. A 1 mm thick dysprosium fluoride membrane was applied to the surface of the magnet by using the dipping process, followed by 15 h of incubation at 900° C. for a diffusion treatment. After the diffusion temperature was lowered to below 100° C., the temperature was again raised to 550° C. for a 5-hour aging treatment to prepare and obtain a grain boundary diffusion neodymium-cerium-iron-boron permanent magnet. The final magnet was subjected to magnetic performance testing.

### Comparative Example 5

In Example 5, the post-sintering aging magnet of Comparative Example 2 was used and processed into a sheet product measuring 20 mm in length, 20 mm in width, and 5 mm in thickness. A 1 mm thick dysprosium fluoride membrane was applied to the surface of the magnet by using the dipping process, followed by 15 h of incubation at 900° C. for a diffusion treatment. After the diffusion temperature was lowered to below 100° C., the temperature was again raised to 550° C. for a 5-hour aging treatment to prepare and obtain a grain boundary diffusion neodymium-cerium-iron-boron permanent magnet. The final magnet was subjected to magnetic performance testing.

### Example 4

(1) The component proportions were designed on a 100 mass % basis as follows: PrNd: 32.6 wt. %, Dy: 0.4 wt. %, Co: 1.3 wt. %, Cu: 0.38 wt. %, Ga: 0.1 wt. %, Al: 0.6 wt. %, Ti: 0.14 wt. %, Zr: 0.1 wt. %, B: 0.99 wt. %, and Fe balance. Main phase alloy starting materials were weighed out and smelted by using a vacuum induction smelting furnace in an Ar atmosphere, and the molten liquid was cast at a temperature of 1400° C. onto a water-cooled copper roller rotating at a rotation speed of 32 rpm to prepare and obtain main phase alloy scales with a mean thickness of 0.27 mm.

(2) The component proportions were designed on a 100 mass % basis as follows: PrNd: 19.3 wt. %, Ce: 13.7 wt. %, Dy: 0.4 wt. %, Co: 1.3 wt. %, Cu: 0.1 wt. %, Ga: 0.1 wt. %, Al: 0.35 wt. %, Ti: 0.1 wt. %, Zr: 0.1 wt. %, B: 0.99 wt. %, and Fe balance. Auxiliary phase alloy starting materials were weighed out and smelted by using a vacuum induction smelting furnace in an Ar atmosphere, and the molten liquid was cast at a temperature of 1400° C. onto a water-cooled copper roller rotating at a rotation speed of 36 rpm to prepare and obtain auxiliary phase alloy scales with a mean thickness of 0.25 mm.

(3) The main phase alloy scales and the auxiliary phase alloy scales were subjected to hydrogen decrepitation, dehydrogenation, and jet milling to prepare an alloy powder with a mean grain size of 5 μm and an alloy powder with a mean grain size of 3.5 μm, respectively. The alloy powders were mixed in a mass ratio of 2.7:1 in a N₂ atmosphere, and tributyl borate was added as a lubricant in an amount of 0.05 wt % of the alloy powders and homogenously stirred and mixed.

(4) The mixed powder was added to the mold cavity of a press-molding device mold in a N₂ atmosphere, subjected to oriented press molding with an orientation magnetic field strength of 3 T, and then subjected to an isostatic pressing treatment in an isostatic press at a pressure of 185 MPa for 8 s to obtain a compact with a density of 4.2 g/cm³.

(5) The compact was placed in a sintering furnace and treated with heat in a vacuum atmosphere. The compact was incubated at 150° C. for 100 min and 260° C. for 100 min to remove the lubricant, and incubated at 600° C. for 90 min and 900° C. for 90 min to be degassed. Then a 4-stage sintering-incubation process was performed, and after each sintering-incubation stage, the temperature was lowered to 990° C. before the next heating procedure. The specific sintering process is shown in Table 2. After the fourth sintering-incubation stage, the product was directly cooled to room temperature to obtain a sintered body.

(6) Aging treatment: The sintered body described above was heated to 900° C. and incubated for 180 min, then cooled to 200° C., heated again to 530° C. and incubated for 240 min, and then cooled to room temperature to obtain a post-aging treatment magnet. The neodymium-cerium-iron-boron permanent magnet has the following chemical formula: (Ce_{0.11}RH_{0.01}RL_{0.88})_{33.1}Fe_{63.56}TM_{2.35}B_{0.99};
the element RH was Dy, and the element RL was Pr and Nd; the element TM was Co, Cu, Ga, Al, Zr, and Ti.

### Comparative Example 6

Comparative Example 6 differs from Example 4 only in that Comparative Example 6 used a 3-stage sintering-incubation process. The specific sintering process is shown in Table 2.

### Example 5

Example 5 differs from Example 4 only in the powder preparation step (3). In Example 5, the main phase alloy scales and the auxiliary phase alloy scales were mixed in a mass ratio of 2.7:1 and then subjected to hydrogen decrepitation, dehydrogenation, and jet milling to prepare an alloy powder with a mean grain size of 3.7 μm, and tributyl borate was added as a lubricant in an amount of 0.05 wt % of the alloy powder in a N₂ atmosphere and homogenously stirred and mixed.

### Comparative Example 7

Comparative Example 7 differs from Example 5 only in that Comparative Example 7 used a 3-stage sintering-incubation process. The specific sintering process is shown in Table 2.

TABLE 2
Heating-incubation sintering process parameters
for Examples 4-5 and Comparative Examples 6-7

| | First | First | First | Second | Second | Second |
|---|---|---|---|---|---|---|
| | heating | incubation | incubation | heating | incubation | incubation |
| | rate | temperature | time | rate | temperature | time |
| | (° C./min) | (° C.) | (min) | (° C./min) | (° C.) | (min) |
| Example 4 | 3 | 1040 | 80 | 3 | 1040 | 80 |
| Comparative | 3 | 1040 | 80 | 3 | 1040 | 80 |
| Example 6 | | | | | | |
| Example 5 | 3 | 1050 | 80 | 3 | 1050 | 80 |
| Comparative | 3 | 1050 | 80 | 3 | 1050 | 80 |
| Example 7 | | | | | | |
| | Third | Third | Third | Fourth | Fourth | Fourth |
| | heating | incubation | incubation | heating | incubation | incubation |
| | rate | temperature | time | rate | temperature | time |
| | (° C./min) | (° C.) | (min) | (° C./min) | (° C.) | (min) |
| Example 4 | 3 | 1040 | 80 | 3 | 1040 | 80 |
| Comparative | 3 | 1040 | 80 | — | — | — |
| Example 6 | | | | | | |
| Example 5 | 3 | 1050 | 80 | 3 | 1040 | 80 |
| Comparative | 3 | 1050 | 80 | 3 | 1040 | 80 |
| Example 7 | | | | | | |

The post-aging treatment magnets of Examples 1-5 and Comparative Examples 1-7 were each processed into a standard φ10-10 sample column. The performance of the magnets was tested using a BH instrument, and the specific magnetic performance test results are obtained.

The magnetic performance of the magnets prepared in Examples 1-5 and Comparative Examples 1-7 described above were tested using an NIM-62000 permanent magnet material precision measuring system; the magnets were analyzed using a field-emission electron probe microanalyzer (FE-EPMA) (JEOL, 8530F), and area ratios were analyzed using Image-Pro Plus software. The results are shown in Table 3 below;
wherein the ratio of the area of RE-rich phases to the entire visual field area is denoted by area ratio S1;
the mean ratio of the total area of block-like grain boundary RE-rich phases at a junction of no less than three main phase grains to the total area of all of no less than three nearby, adjacent main phase grains is S2.

The mean grain size is the mean grain size of the main phase grains.

TABLE 3
Performance of the products of Examples
1-5 and Comparative Examples 1-7

| | | | | Mean | | |
|---|---|---|---|---|---|---|
| | Br | Hcj | | grain | | |
| | (T) | (kA/m) | Squareness | size | S1 | S2 |
| Example 1 | 1.291 | 1421 | 0.992 | 5.7 | 7.9 | 6.1 |
| Example 2 | 1.299 | 1455 | 0.996 | 5.4 | 7.5 | 5.8 |
| Comparative | 1.277 | 1241 | 0.974 | 7.1 | 10.2 | 10.3 |
| Example 1 | | | | | | |
| Comparative | 1.283 | 1283 | 0.981 | 6.7 | 9.1 | 8.5 |
| Example 2 | | | | | | |
| Comparative | 1.321 | 1537 | 0.996 | 4.9 | 6.8 | 5.6 |
| Example 3 | | | | | | |
| Comparative | 1.318 | 1508 | 0.989 | 5.3 | 7.1 | 6.2 |
| Example 4 | | | | | | |
| Example 3 | 1.275 | 2162 | 0.984 | — | — | — |
| Comparative | 1.264 | 1797 | 0.963 | — | — | — |
| Example 5 | | | | | | |
| Example 4 | 1.299 | 1479 | 0.988 | 5.5 | 7.7 | 5.9 |
| Comparative | 1.281 | 1306 | 0.973 | 6.4 | 8.9 | 8.6 |
| Example 6 | | | | | | |
| Example 5 | 1.287 | 1466 | 0.986 | 5.9 | 8.1 | 6.3 |
| Comparative | 1.274 | 1298 | 0.975 | 7.4 | 9.4 | 8.8 |
| Example 7 | | | | | | |

In Table 3, “-” represents no detection.

It can be seen from a comparison of Example 1 and Comparative Example 1 that the use of the 4-stage sintering-incubation process effectively reduced the area ratio of block-like grain boundary phase RE-rich phases, making grain boundary phase RE-rich phases finer, significantly improving the magnetic performance of the magnet.

It can be seen from comparisons of Example 1, Example 2, and Comparative Example 2 that the use of the 5-stage sintering-incubation process can further improve the performance of magnets; however, the improvement is limited. The 4-stage sintering-incubation process resulted in a significantly better improvement in performance (see Example 1) than the 3-stage sintering-incubation process (see Comparative Example 2).

The improvements in magnetic performance, S1, and S2 between Example 1 and Comparative Example 2 were significantly better than the improvements in magnetic performance, S1, and S2 between Example 3 and Comparative Example 4, indicating that the use of the 4-stage sintering-incubation process resulted in significantly better improvements in the performance of magnets high in Ce content than in the performance of magnets low in Ce content.

It can be seen from a comparison of Example 3 and Comparative Example 5 that the use of the 4-stage sintering-incubation process can optimize grain boundary phase distribution, thereby significantly improving the diffusion effect within magnets.

It can be seen from a comparison of Example 4 and Comparative Example 6 and a comparison of Example 5 and Comparative Example 7 that the magnetic performance of dual-alloy magnets prepared using the 4-stage sintering-incubation process was also better than that of magnets prepared using the 3-stage sintering-incubation process.

The embodiments of the present disclosure have been described above. However, the present disclosure is not limited to the embodiments described above. Any modification, equivalent replacement, improvement, etc. made without departing from the spirit and principle of the present disclosure shall fall within the protection scope of the present disclosure.

1. A neodymium-cerium-iron-boron permanent magnet, wherein the neodymium-cerium-iron-boron permanent magnet has at least one of the following characteristics:
the area of grain boundary RE-rich phases within the magnet accounts for no less than 4% of an entire visual field area;
the grain boundary RE-rich phases within the magnet exhibit a uniform and fine distribution;
the mean ratio of the area of block-like grain boundary RE-rich phases at the junction of no less than three main phase grains to the total area of all of no less than three nearby adjacent main phase grains is ≤30%.

2. The neodymium-cerium-iron-boron permanent magnet according to claim 1, wherein the RE comprises neodymium (Nd) and may also comprise at least one rare earth element selected from the following: cerium (Ce), lanthanum (La), praseodymium (Pr), yttrium (Y), gadolinium (Gd), terbium (Tb), dysprosium (Dy), and holmium (Ho);
preferably, the area of grain boundary RE-rich phases within the magnet accounts for no less than 6% of the entire visual field area;
preferably, the mean ratio of the area of block-like grain boundary RE-rich phases at the junction of no less than three main phase grains to the total area of all of no less than three nearby adjacent main phase grains is ≤15%, more preferably ≤10%, and more preferably ≤7%;
preferably, the main phase has an R₂Fe₁₄B structure;
preferably, main phase grains of the neodymium-cerium-iron-boron permanent magnet have a mean grain size of 5-10 μm.

3. The neodymium-cerium-iron-boron permanent magnet according to claim 1, wherein the neodymium-cerium-iron-boron permanent magnet has the following chemical formula: (CeₐRH_{b}RL_{1-a-b})ₓFe_{100-x-y-z}TM_{y}B_{z};
wherein: 20≤x≤40, 0.5≤y≤10, 0.9≤z≤1.5, 0.05≤a≤0.65, and 0≤b≤0.25; the element RH is at least one of Dy, Tb, Ho, and Gd, and the element RL is selected from at least one of Pr, Nd, La, and Y and comprises at least Nd; the element TM is at least one of Co, Cu, Ga, Al, Zr, and Ti;
preferably, 25≤x≤35, 1≤y≤5, 0.9≤z≤1.3, 0.05≤a≤0.25, and 0.01≤b≤0.1.

4. A preparation method for the neodymium-cerium-iron-boron permanent magnet according to claim 1, wherein the method comprises: subjecting starting materials comprising element Ce, element RL, element Fe, element TM, and element B and a starting material of the element RH, which is optionally present or absent, to powder preparation, pressing, sintering, and an aging treatment to prepare and obtain the neodymium-cerium-iron-boron permanent magnet;
preferably, the method comprises: subjecting starting materials comprising the element Ce, the element RL, the element Fe, the element TM, the element B, and the element RH to powder preparation, pressing, and sintering to prepare and obtain the neodymium-cerium-iron-boron permanent magnet;
preferably, the method also comprises adding a lubricant, wherein the lubricant is selected from one or more of calcium stearate, zinc stearate, tributyl borate, isopropanol, and petroleum ether;
preferably, the lubricant may be used in an amount of 0.01-2 wt % of a total weight of the powder.

5. The preparation method according to claim 4, wherein the method also comprises:
(K1) preparing Ce-free main phase alloy scales and Ce-containing auxiliary phase alloy scales first;
wherein the Ce-free main phase alloy scales are prepared by subjecting starting materials of the element RL, the element Fe, the element TM, and the element B, and the element RH, which is optionally present or absent, to smelting and condensation;
the Ce-containing auxiliary phase alloy scales are prepared by subjecting starting materials of the element Ce, the element RL, the element Fe, the element TM, and the element B, and the element RH, which is optionally present or absent, to smelting and condensation;
(K2) subjecting the Ce-free main phase alloy scales and the Ce-containing auxiliary phase alloy scales of step (K1) to hydrogen decrepitation, dehydrogenation, and jet milling to prepare alloy powders, optionally adding the lubricant or not, and performing pressing, sintering, and the aging treatment to prepare and obtain the neodymium-cerium-iron-boron permanent magnet;
preferably, the method also comprises: (S1) preparing Ce-free main phase alloy scales and Ce-containing auxiliary phase alloy scales first, and subjecting the Ce-free main phase alloy scales and the Ce-containing auxiliary phase alloy scales to hydrogen decrepitation, dehydrogenation, and jet milling to prepare a main phase alloy powder and an auxiliary phase alloy powder, respectively;
wherein the Ce-free main phase alloy scales and the Ce-containing auxiliary phase alloy scales have the meanings described above;
(S2) mixing the main phase alloy powder and the auxiliary phase alloy powder of step (S1), optionally adding the lubricant or not, and performing pressing, sintering, and the aging treatment to prepare and obtain the neodymium-cerium-iron-boron permanent magnet;
preferably, in step (S2), the neodymium-cerium-iron-boron permanent magnet is prepared and obtained by mixing the main phase alloy powder and the auxiliary phase alloy powder of step (S1), adding the lubricant, and performing pressing, sintering, and the aging treatment;
preferably, in step (S2), the mass ratio of the main phase alloy powder to the auxiliary phase alloy powder is (1-40):1.

6. The preparation method according to claim 4, wherein the preparation method also comprises press-molding the alloy powders into a compact;
preferably, the press molding comprises orientated press molding and isostatic press molding;
preferably, the orientation magnetic field has a magnetic field strength of 2-5 T;
preferably, the isostatic press molding is performed at a pressure of 150-260 MPa;
preferably, the compact has a density of 4-6 g/cm³.

7. The preparation method according to claim 4, wherein the sintering is vacuum liquid-phase sintering having no less than four sintering-incubation stages, e.g., 4-10 sintering-incubation stages; temperatures of the sintering-incubation stages are 900-1150° C.; incubation temperatures of a plurality of incubation stages are the same or different; incubation times are 40-140 min;
preferably, each of the sintering-incubation stages is preceded by a heating stage, and the heating rate of the heating stage is 0.5-5° C./min, more preferably 1-4° C./min;
preferably, between every two adjacent sintering-incubation processes, the previous sintering-incubation stage is immediately followed by the next heating-incubation procedure, or after the previous sintering-incubation stage, cooling is performed before the next heating-incubation procedure; preferably, after the previous sintering-incubation stage, 1-10 stages of cooling are performed before the next heating-incubation procedure; preferably, after incubation, the cooling is performed at a temperature of 500-1050° C.

8. The preparation method according to claim 4, wherein the aging treatment is performed after the sintering treatment cooling;
preferably, the aging treatment is a two-stage aging treatment comprising: heating to perform a primary aging treatment at a temperature of 800-950° C., with an incubation time of 160-300 min;
cooling to a temperature of no more than 210° C., and then heating to perform a secondary aging treatment at a temperature between 450° C. and 600° C., with an incubation time of 240-360 min.

9. The preparation method according to claim 4, wherein the method also comprises a grain boundary diffusion treatment step: after grinding the surface of the neodymium-cerium-iron-boron permanent magnet prepared after sintering, coating the surface with a heavy rare earth diffusion source, and after a diffusion treatment, preparing a grain boundary diffusion neodymium-cerium-iron-boron permanent magnet.

10. Use of the neodymium-cerium-iron-boron permanent magnet according to claim 1 in the fields of rare earth permanent magnet motors, intelligent consumer electronic products, and medical devices.
